(19) United States
(12) Patent Application Publication
(10) Pub. No.: US 2002/0183425 A1
(43) Pub. Date: Dec. 5, 2002

(54) POLYMER COMPOSITION

(76) Inventors: DR. MICHAEL ROMER, RUSSELSHEIM (DE); ANASTASIOS DIMITRIADIS, RUSSELSHEIM (DE); DIRK RAUDIES, ELSOFF (DE)

Correspondence Address: CONNOLLY BOVE LODGE & HUTZ, LLP, 1220 N MARKET STREET, P O BOX 2207, WILMINGTON, DE, 19899

(21) Appl. No.: 08/993,426

(22) Filed: Dec. 18, 1997

(30) Foreign Application Priority Data
Dec. 20, 1996 (DE) 19653357

(51) Int. Cl. C08K 5/51

(52) U.S. Cl. 524/128

(57) ABSTRACT

The present invention relates to a polymer composition which contains from 5.0% by weight to 95.0% by weight of at least one thermotropic liquid crystalline copolymer, from 5.0% by weight to 95.0% by weight of at least one thermoplastically processable polycarbonate and from 0.01 % by weight to 5.0% by weight of at least one reinforcing agent. The present invention furthermore relates to a process for the preparation of the polymer composition and its use.

The present invention relates to a novel injection molding composition, a process for its preparation and its use.

EP-A44175 discloses a polymer composition which comprises from 5 to 75% by weight of polycarbonate and from 25 to 95% by weight of a wholly aromatic thermoplastically processable anisotropic melt of a copolyester and is processed at below 350° C.

EP-A-217 563 discloses a self-reinforced polymeric composite material which comprises a thermoplastic base polymer having a flexible chain and from about 2 to about 20% by weight, based on the combined weight of the base polymer and of the liquid crystalline polymer, of a melt-processable liquid crystalline polymer which is incompatible with the base polymer. The liquid crystalline polymer is present in the form of fibers which are oriented essentially in one direction and are formed in situ in a matrix of the base polymer. The polymer composition exhibits only slight self-reinforcing effects. The reinforcing effect described is based on shearing-induced formation of liquid crystalline polymer fibers which reinforce the matrix.

EP-A-30417 discloses a melt-processable polymer composition which contains from 0.50 to 20% by weight of at least one polymer which permits the formation of an anisotropic melt and at least one other fusible polymer. In the polymer composition, the temperature ranges in which on the one hand the polymer can form an anisotropic melt and on the other hand the fusible polymer can be melted overlap. Here, the melt viscosity-reduced effect of liquid crystalline polymers in the melt is utilized as a flow improver. It is an object of the present invention to provide a polymer composition which has good mechanical properties, in particular in thin walls. A further object of the present invention is to provide an economical and environmentally friendly process for the preparation of this polymer composition.

The present invention is achieved by a polymer composition which contains from 5.0% by weight to 65.0% by weight of at least one thermotropic liquid crystalline copolymer, from 35% by weight to 95.0% by weight of at least one thermoplastically processable polycarbonate and from 0.01 % by weight to 5.0% by weight of at least one reinforcing agent. This polymer composition according to the invention has surprisingly good mechanical properties, in particular in thin walls.

The self-reinforcing effect of the liquid crystalline polymer is revealed in the product brochure Vectra, Hoechst AG, 1992. If the liquid crystalline polymer is used in the form of fibrils or in drop form as reinforcing material in the polymer composition, for example in a polycarbonate matrix, its self-reinforcing effect is only small. It was found, surprisingly, that good mechanical properties are obtained in the case of such polymer compositions, in particular in thin walls, by adding the reinforcing agents according to the invention.

A preferred embodiment of the invention is a polymer composition which contains rom 7.5% by weight to 40.0% by weight of at least one thermotropic liquid crystalline copolymer, from 60.0% by weight to 92.5% by weight of at least one thermoplastically processable polycarbonate and from 0.05% by weight to 3.0% by weight of at least one reinforcing agent. This polymer composition according to the invention surprisingly has very good mechanical properties, in particular in thin walls.

A particularly preferred embodiment of the invention is a polymer composition which contains from 10.0% by weight to 25.0% by weight of at least one thermotropic liquid crystalline copolymer, from 75% by weight to 90.0% by weight of at least one thermoplastically processable polycarbonate and from 0.1% by weight to 1.5% by weight of at least one reinforcing agent. This polymer composition according to the invention surprisingly has extremely good mechanical properties, in particular in thin walls.

In the polymer composition according to the invention, the thermotropic liquid crystalline copolymer has recurring units of the formulae (I) to (VI):

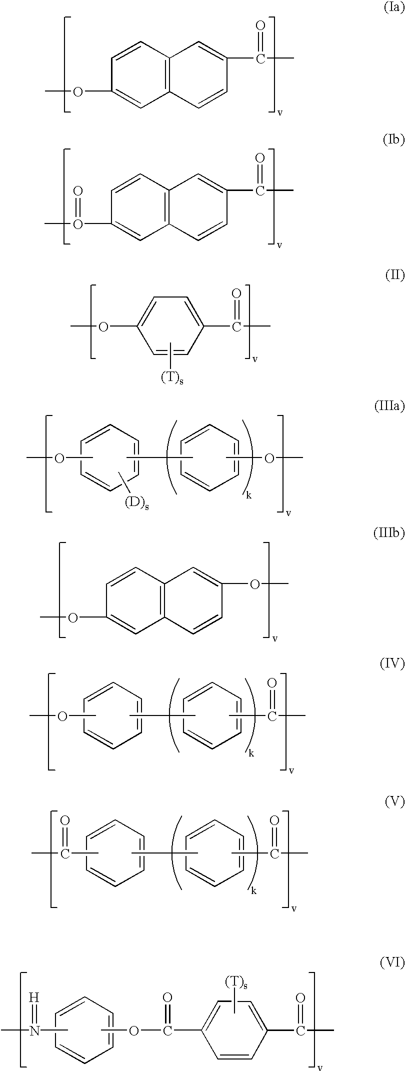

In the formulae (I) to (VI),

T are identical or different and are a C₁-C₄-alkyl group, a C₁-C₄-alkoxy group or a halogen atom,

D are identical or different and are a C₁-C₄-alkyl group, a C₆-C₁₀-aryl group, a C₆-C₁₀-aralkyl group or a halogen atom,

s is an integer from 1 to 4,

k is the integer 0 or 1 and

v is an integer≧1.

Liquid crystalline copolymers which contain naphthalene compounds are known as wholly aromatic composite material under the brands ®Vectra A 130, ®Vectra C 130, ®Vectra E 130, ®Vectra RD 501, ®Vectra RD 2001, Zenite® 6130, Zenite® 7130 and Thermix®. Liquid crystalline copolymers which contain naphthalene 5 compounds and aminophenol are known under the brands ®Vectra B, ®Vectra L and ®Vectra Ei. Liquid crystalline copolymers which contain biphenyl units are known under the brands Amoco® G 930, Sumikasuper® E 6008 and ®Vectra E 130.

In the polymer composition according to the invention, the thermoplastically processable polycarbonate is a compound having the general structural formula

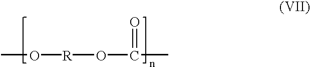

in which

R is an organic group, such as a C₁-C₄-alkyl group, C₁-C₄-alkoxy group, C₆-C₁₀-aryl group or C₆-C₁₀-aralkyl group and

n is an integer≧1.

The polycarbonates based on bisphenol are particularly suitable. Polycarbonates which contain the monomer according to formula (VII′) are very particularly suitable.

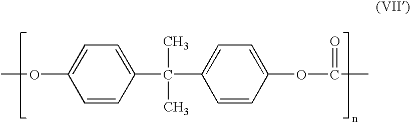

Polycarbonates such as poly[oxycarbonyloxy-1,4-phenylene-(1-methylethylidene)-1,4-phenylene] (Makrolon®) and other polycarbonates which are known under the brands Lexan®, Apec® or Calibre® are particularly preferred. Furthermore, blends of polycarbonate and acrylonitrile-butadiene-styrene (ABS) are very suitable as polycarbonate components. These polycarbonate/ABS blends are known under Baybiend® or Cycoloy®.

The reinforcing agents according to the invention preferably have bifunctional or trifunctional structural units. These are preferably phosphorus-containing compounds, such as pentaerythrityl phosphite esters, such as bis(2,4-di-tert-butylphenyl)pentaerythrityl diphosphite ester (Ultranox® 626). 1,2,4,5-Benzenetetracarboxylic acid (pyromellitic acid) or pyromellitic anhydride, silicone elastomer-modified polyetherimides Siltem®, crosslinked silicone elastomers, such as siloxane or based on siloxane with 5% by weight of terminal carboxyl groups, such as SLM 445048, or siloxane with 25% by weight of terminal phenyl groups and terminal carboxyl groups, such as SLM 445045 or mixtures of the compounds are further reinforcing agents according to the invention. The reinforcing agent used increases the self-reinforcing effect of the liquid crystalline copolymer.

Preferred reinforcing agents are mixtures of phosphite esters with siltem and pyromellitic acid with silicone elastomers.

According to the invention, it is envisaged that the polymer composition will be processed to give granules. For this purpose, a mixture of at least one liquid crystalline copolymer, at least one polycarbonate and at least one reinforcing agent is melted in the weight ratio described above and is extruded. The extrudate is comminuted, granules of from about 3 to 4 mm being produced. The granules produced according to the invention can particularly preferably be processed to give shaped articles according to the invention.

According to the invention, the use of a reinforcing agent for enhancing the mechanical properties of the polymer composition with decreasing wall thicknesses of the injection molded articles is envisaged. The increase in the tensile modulus of elasticity is at least 25% and that in the tensile strength at least 15% with a reduction of wall thickness from 4.0 to 1.6 mm.

According to the invention, the use of a polymer composition for the production of thin-walled housing parts is envisaged. The granules produced according to the invention are used for the production of the thin-walled housing parts.

The present invention is illustrated in more detail by means of the following examples.

The mixture was melted in a ZSK 25 twin-screw extruder from Werner and Pfleiderer. An extrudate was produced. The extrudate was comminuted, granules having a length of from about 3 to 4 mm being produced. The granules were melted at a temperature of 290° C. in a KT 90 injection molding machine from Klöckner Ferromatic. The melt was injected into a tensile test bar mold at a pressure of 1900 bar and an average injection rate of 350 mm/s. The bars (iso tensile test bars) having an wall thickness of 4.0, 3.2 and 1.6 mm were injection molded.

For comparison, the mixture was melted directly at a temperature of 290° C. in a KT 90 injection molding machine from Klöckner Ferromatic. The melt was injected into a tensile test bar mold at a pressure of 1900 bar and an average injection rate of 350 mm/s. Bars (iso tensile test bars) having wall thicknesses of 4.0, 3.2 and 1.6 mm were injection molded.

The bars produced were placed on a tensile tester, type 43.02 H 3570, from Instron. On the tensile tester, the tensile modulus of elasticity, the tensile strength and the elongation at break of the respective bar were measured.

### EXAMPLES

### Example 1

A mixture of 4.0 g of polycarbonate Makrolon® 2400, 1.0 kg of liquid crystalline copolymer ®Vectra A 950 and 0,05 kg of Ultranox® 626 was produced. The mixture was melted in a twin-screw extruder and was extruded. The extrudate was comminuted, granules having a length of from about 3 to 4 mm being produced. The granules were dried for 4 h at 120° C. and injection molded in an injection molding machine to give bars (iso bar). The values of the tensile tests on the tensile tester are shown in Table 1 below.

TABLE 1

| | Tensile | | |
|---|---|---|---|
| Wall | modulus of | Tensile | Elongation at |
| thickness | elasticity | strength | break |
| [mm] | [PMa] | [PMa] | [%] |
| 4.0 | 3502 | 79.8 | 4.1 |
| 3.2 | 3882 | 88.7 | 4.2 |
| 1.6 | 4473 | 103.1 | 4.7 |

### Example 2

Example 2 was carried out analogously to Example 1, 0.05 kg of silicone elastomer SLM 445048 (Wacker) being used as a reinforcing agent. The values of the tensile tests on the tensile tester are shown in Table 2 below.

TABLE 2

| | Tensile | | |
|---|---|---|---|
| Wall | modulus of | Tensile | Elongation at |
| thickness | elasticity | strength | break |
| [mm] | [PMa] | [PMa] | [%] |
| 4.0 | 3170 | 74.4 | 4.1 |
| 3.2 | 3461 | 84.1 | 4.4 |
| 1.6 | 4717 | 111.3 | 4.1 |

### Example 3

Example 3 was carried out analogously to Example 1, 0.05 kg of Ultranox® 626 (0.1%) and 0.25 kg of Siltem® ST 1500 (0.5%) being used as reinforcing agents. The values of the tensile tests on the tensile tester are shown in Table 3 below.

TABLE 3

| | Tensile | | |
|---|---|---|---|
| Wall | modulus of | Tensile | Elongation at |
| thickness | elasticity | strength | break |
| [mm] | [PMa] | [PMa] | [%] |
| 4.0 | 2908 | 70.1 | 4.0 |
| 3.2 | 3214 | 77.0 | 4.3 |
| 1.6 | 3357 | 85.3 | 4.3 |

### Example 4

Example 4 was carried out analogously to Example 1, the polymer mixture containing 3.5 kg of Makrolon 2400 (67.5%) and 1.5 kg of Vectra A 950 (30%), and 0.1 kg of pyromellitic acid (2%) and 0.025 kg of silicone elastomer SLM 445025 (0.5%) being used as reinforcing agents. The values of the tensile tests on the tensile tester are shown in Table 4 below.

TABLE 4

| | Tensile | | |
|---|---|---|---|
| Wall | modulus of | Tensile | Elongation at |
| thickness | elasticity | strength | break |
| [mm] | [PMa] | [PMa] | [%] |
| 4.0 | 3918 | 64.7 | 1.9 |
| 3.2 | 4300 | 76.6 | 2.2 |
| 1.6 | 4760 | 101.6 | 2.4 |

### Example 5

Example 5 was carried out analogously to Example 1, 0.05 kg of pyromellitic acid (0.1%) and 0.05 kg of Ultranox® 626 (0.1%) being used as reinforcing agents. The values of the tensile tests on the tensile tester are shown in Table 5 below.

TABLE 5

| | Tensile | | |
|---|---|---|---|
| Wall | modulus of | Tensile | Elongation at |
| thickness | elasticity | strength | break |
| [mm] | [PMa] | [PMa] | [%] |
| 4.0 | 3262 | 69.1 | 3.2 |
| 3.2 | 3604 | 78.4 | 3.3 |
| 1.6 | 4134 | 86.1 | 2.9 |

### Comparative Example 1

Comparative Example 1 was carried out analogously to Example 1, except that no reinforcing agent was used. A mixture of 4 kg of polycarbonate and 1 kg of LCP ®Vectra A 950 was prepared. The mixture was extruded. The extrudate was comminuted, granules having a length of from about 3 to 4 mm being produced. The granules were dried for 4 h at 120° C. and processed on an injection molding machine. Bars (iso bars) were injection molded. The values of the tensile tests on the tensile tester are shown in Table 6 below.

TABLE 6

| | Tensile | | |
|---|---|---|---|
| Wall | modulus of | Tensile | Elongation at |
| thickness | elasticity | strength | break |
| [mm] | [MPa] | [MPa] | [%] |
| 4, 0 | 2480 | 43.6 | 3.2 |
| 3, 2 | 2481 | 44.5 | 2.3 |
| 1, 6 | 2576 | 50.7 | 7.2 |

### Comparative Example 2

Comparative Example 2 was carried out with 4 kg of polycarbonate in the form of granules and 1 kg of LCP ®Vectra A 950, similarly to Example 1 and Comparative Example 1, except that the mixture was melted directly at a temperature of 290° C. in an injection molding machine. The melt was injected into a tensile test bar mold. The values of the tensile tests on the tensile tester are shown in Table 7 below.

TABLE 7

| | Tensile | | |
|---|---|---|---|
| Wall | modulus of | Tensile | Elongation at |
| thickness | elasticity | strength | break |
| [mm] | [MPa] | [MPa] | [%] |
| 4.0 | 2720 | 63.5 | 5.8 |
| 3.2 | 2653 | 67.7 | 59.1 |
| 1.6 | 2595 | 60.7 | 11.6 |

In Table 8, the mechanical properties of the bars from Example 1 and Comparative Examples 1 and 2 are compared.

TABLE 8

| | | Tensile | | |
|---|---|---|---|---|
| Example/ | Wall | modulus of | Tensile | Elongation at |
| Comparative | thickness | elasticity | strength | break |
| Example | [mm] | [PMa] | [PMa] | [%] |
| E1 | 4.0 | 3502 | 79.8 | 4.1 |
| C1 | 4.0 | 2480 | 43.6 | 3.2 |
| C2 | 4.0 | 2720 | 63.5 | 5.8 |
| E1 | 3.2 | 3882 | 88.7 | 4.2 |
| C1 | 3.2 | 2481 | 44.5 | 2.3 |
| C2 | 3.2 | 2653 | 67.7 | 59.1 |
| E1 | 1.6 | 4473 | 103.1 | 4.7 |
| C1 | 1.6 | 2576 | 50.7 | 7.2 |
| C2 | 1.6 | 2595 | 60.7 | 11.6 |

1. A polymer composition containing
from 5.0% by weight to 65.0% by weight of at least one thermotropic liquid crystalline copolymer,
from 35% by weight to 95.0% by weight of at least one thermoplastically processable polycarbonate and
from 0.01 % by weight to 5.0% by weight of at least one reinforcing agent.

2. The polymer composition as claimed in claim 1, containing
from 7.5% by weight to 40.0% by weight of at least one thermotropic liquid crystalline copolymer,
from 60.0% by weight to 92.5% by weight of at least one thermoplastically processable polycarbonate and
from 0.05% by weight to 3.0% by weight of at least one reinforcing agent.

3. The polymer composition as claimed in claim 1, containing
from 10.0% by weight to 25.0% by weight of at least one thermotropic liquid crystalline copolymer,
from 75.0% by weight to 90.0% by weight of at least one theremoplastically processable polycarbonate and
from 0.1 % by weight to 1.5% by weight of at least one reinforcing agent.

4. The polymer composition as claimed in claim 1, wherein a thermotropic liquid crystalline copolymer has recurring units of the formulae (I) to (VI) 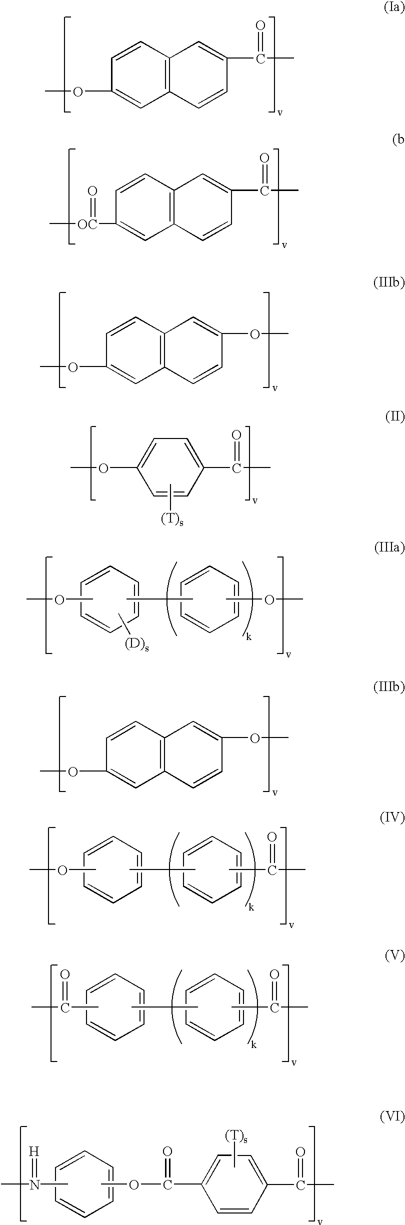
in which
T are identical or different and are a C₁-C₄-alkyl group, a C₁-C₄-alkoxy group or a halogen atom,
D are identical or different and are a C₁-C₄-alkyl group, C₆-C₁₀-aryl group, C₆-C₁₀-aralkyl group or a halogen atom,
s is an integer from 1 to 4,
k is the integer 0 or 1 and
v is an integer≧1.

5. The polymer composition as claimed in claim 1, wherein the thermoplastically processable polycarbonate is at least one compound of the formula (VII) 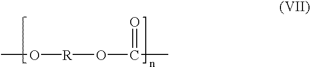
in which
R is an organic group, such as C₁-C₄-alkyl group, C₁-C₄-alkoxy group, C₆-C₁₀-aryl group or C₆-C₁₀-aralkyl group and
n is an integer≧1,
preferably a bisphenol-based polycarbonate which contains the monomer of the formula (VII′)

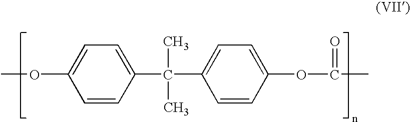

6. The polymer composition as claimed in claim 1, wherein the reinforcing agent is at least one compound, such as phosphorus-containing compound, an aromatic acid, a siloxane or a silicone-modified compoud.

7. The polymer composition as claimed in 1, wherein the reinforcing agent is a mixture of phosphite esters with polyether imides or of pyromellitic acid with silicone elastomers.

8. A process for the preparation of a polymer composition as claimed in claim 1, wherein at least one liquid crystalline copolymer, at least one polycarbonate and at least one reinforcing agent are melted and are extruded and the extrudate is comminuted.

9. The use of a reinforcing agent for enhancing the mechanical properties of the polymer composition with decreasing wall thicknesses of the injection molded articles.

10. The use of a polymer composition as claimed in claim 1 for the production of thin-walled housing parts, long filigree plug connections for chip modules, medical apparatuses and containers which are used for steam-distillation, and glass fibers and glass beads which are filled with minerals or graphite or reinforced with carbon fibers.
